(19) United States
(12) Patent Application Publication
(10) Pub. No.: US 2006/0056609 A1
(43) Pub. Date: Mar. 16, 2006

(54) Telephony integration of customer relationship management

(76) Inventor: David Dickey, Austin, TX (US)

Correspondence Address: CARSTENS & CAHOON, LLP, P O BOX 802334, DALLAS, TX, 75380, US

(21) Appl. No.: 11/199,655

(22) Filed: Aug. 9, 2005

Related U.S. Application Data
(60) Provisional application No. 60/599,968, filed on Aug. 9, 2004.

(51) Int. Cl. H04M 3/08; H04M 11/00; H04M 15/00; H04M 3/22

(52) U.S. Cl. 379/126; 379/32.01; 379/100.06

(57) ABSTRACT

The present invention provides a customer relationship management (CRM) telephony management system. The telephony management system includes a server-based CRM application and CRM extensions that provide access to customer records and enable telephony action. The extensions include changes to CRM screens in the form of additional buttons and menu links A client-based telephony manager application monitors and performs telephony functions and provides a graphical user interface (GUI) with which users may answer incoming calls. The telephony manager application provides telephone functions through the GUI such as dial, transfer, conference. Record, hold, and hang up. A server-based telephony web application hosts custom forms to facilitate communication between CRM records and the telephony manager application. When an incoming call is received, the telephony management system automatically retrieves any existing CRM records associated with the identity of the call and presents them to the user via a GUI.

### CROSS-REFERENCE TO RELATED APPLICATION

This application claims the benefit of and priority to a U.S. Provisional Patent Application No. 60/599,968 filed Aug. 9, 2004, the technical disclosure of which is hereby incorporated herein by reference.

### BACKGROUND OF THE INVENTION

1. Technical Field

The present invention relates generally to telephone-based customer service, and more specifically to a method for adding telephonic capabilities to customer relationship management applications.

2. Description of Related Art

A Customer Relationship Management (CRM) application is an integrated information system that is used to plan, schedule and control the pre-sale and post-sale activities in an organization. The objective for CRM is to enable a customer to interact with a company through various means, e.g., the Internet, telephone, fax, e-mail, and paper mail, and to receive a consistent level of quality service. The integration of all activities allows, e.g., an order placed by phone can be tracked on the Web and vice versa.

Sales and service organizations that utilize CRM applications frequently use telephones. Currently, some CRMs (e.g., Microsoft CRM) provide phone and fax numbers but do not provide dial, transfer, reverse phone number lookups or other phone integrations called “telephony” applications.

Therefore, a need exists for providing advanced telephony applications for CRMs.

### SUMMARY OF THE INVENTION

The present invention provides a customer relationship management (CRM) telephony management system. The telephony management system includes a server-based CRM application and CRM extensions that provide access to customer records and enable telephony action. The extensions include changes to CRM screens in the form of additional buttons and menu links. A client-based telephony manager application monitors and performs telephony functions and provides a graphical user interface (GUI) with which users may answer incoming calls. The telephony manager application provides telephone functions through the GUI such as dial, transfer, conference, record, hold, and hang up. A server-based telephony web application hosts custom forms to facilitate communication between CRM records and the telephony manager application. When an incoming call is received, the telephony management system automatically retrieves any existing CRM records associated with the identity of the call and presents them to the user via a GUI.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a telecommunication system 100 in which the present invention may be implemented;

FIG. 2 depicts the system architecture of the CRM telephony interface in accordance with the present invention;

FIG. 3 depicts the Telephony Manager Application GUI in accordance with the present invention;

FIG. 4 depicts the process flow for handling inbound calls implemented by the Telephony Manager Application upon detection of an incoming call;

FIG. 5A depicts the TM pop up window displayed when an incoming call is received while the system is searching for account information;

FIG. 5B depicts the TM pop up window displayed for an incoming call with matched account information;

FIG. 5C depicts the TM pop up window with options clicked;

FIG. 5D depicts the TM pop up window for an incoming call with no matches found in the record;

FIG. 6A depicts a Phone Activity View Record;

FIG. 6B depicts the Phone Activity View Record in maximize mode;

FIG. 7 depicts a pop up screen displayed if multiple records match an incoming call;

FIG. 8 depicts the Advance Find page in accordance with the present invention;

FIG. 9 depicts the process flow of the Telephony Manager initialization sequence; and

FIG. 10 depicts CRM integration into the Telephony Manager Application.

### DETAILED DESCRIPTION OF THE INVENTION

The present invention provides a set of tools and extensions to a Customer Relationship Management (CRM) package to provide telephony functionality during the service and the sales cycles in an organization. The present invention is intended to be easily deployable, upgradeable and to survive future CRM upgrades. For purposes of illustration, the description below will use the example of MICROSOFT's CRM (hereinafter “MS CRM”). However, it should be pointed out that the present invention may be implemented with other CRMs with similar capabilities to Microsoft's.

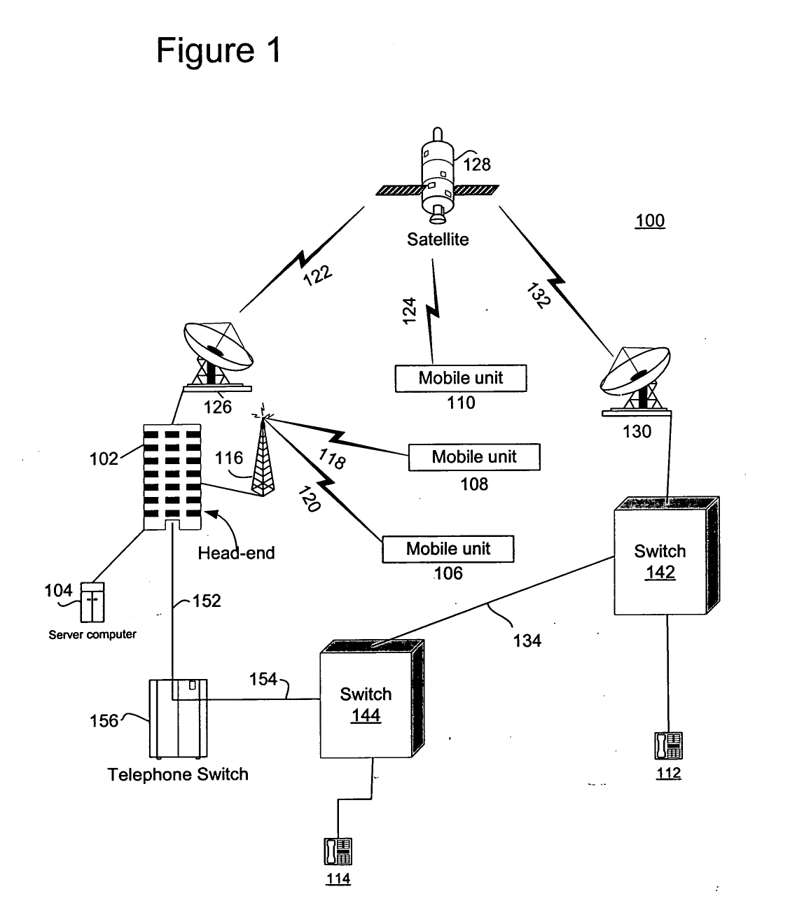

With reference now to the figures and in particular with reference to FIG. 1, a diagram depicts a telecommunication system 100 in which the present invention may be implemented. In this example, head-end 102 is connected to a server computer 104, which is employed to collect data from various computing platforms that may be present within computing system 100. In particular, server computer 104 may communicate with various telephone units 106-114, either mobile or landline. These units each contain a computing platform, which may communicate with server 104. In this example, communications between various mobile units may be accomplished through a cellular or other wireless phone system, through a satellite phone system or landline systems.

Communications between server computer 104 and telephone units 106-114 is accomplished in a number of different ways in this example. For example, radio tower 116 provides communications links 118 and 120 to mobile units 108 and 106 respectively. Communications links 118 and 120 are radio frequency communications links generated between radio tower 116 and antennas located at mobile units 106 and 108. In addition, server 104 may communicate with mobile unit 110 through communications links 122 and 124. Communications link 122 is established between satellite dish 126 and satellite switch 128 with communications link 124 being established between satellite 128 and mobile unit 110. Communications links 122 and 124 are radio frequency based links generated by signals sent to satellite switch 128 from satellite dish 126 and from satellite switch 128 to mobile unit 110. In this example, radio tower 116 and satellite dish 126 are connected to head-end 102 and provide for transmissions originating from or passing through head-end 102.

Further, signals may be sent from satellite switch 128 to satellite dish 130 via communications link 132. From satellite dish 130, information may be sent to telephone unit 114 through communications link 134. Communications link 134 in this example is a link between switch 142 and switch 144. In this manner, a path may be established from server computer 104 to telephone unit 114 to create a path containing communications links 122, 132, and 134. Communications link 134 is a physical link, which may be for example, coaxial cable, fiber optic cable, or a combination of the two. Each switch also has a “link”, also called a “path” within the switch for writing data through the switch. An “input link” is the input or source portion of the link associated with the input into the switch, and an “output link” is the output or destination portion of the link associated with the output from the switch. Similarly, communications with telephone unit 112 may be established through a path containing communications links 122 and 132, through switch 142.

In addition, server computer 104 may use an alternate path to communicate with telephone 114. For example, a path through communications links 152 and 154 may be employed to communicate with unit 114. Links 152 and 154 are physical links in this example. Communications link 152 is established between head-end 102 and switch 156, while communications link 154 is established between switch 156 and switch 144.

In this manner, data signals, such as multi-media data, which may include video, graphics, voice, and text may be sent between server computer 104 and telephone units 106-114.

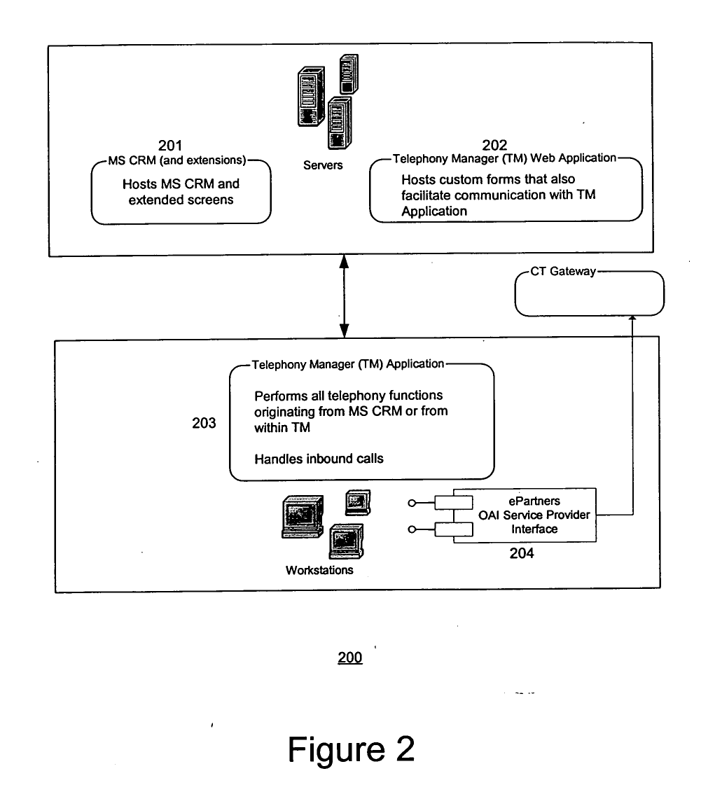

FIG. 2 depicts the system architecture of the CRM telephony interface in accordance with the present invention. The Telephony Management System of the present invention is intended to provide CRM users the ability to interact with the telephony features related to their activities with the MS CRM package. The system 200 consists of three major components: 1) MS CRM (and extensions) 201 to enable Telephony Actions, 2) a Telephony Manager (TM) Web Application 202 to host custom forms, and 3) TM application 203 to monitor and perform the Telephony Actions. The overall system is intended to be seamless to the end-user from a usability standpoint.

The MS CRM extensions 201 are built on standard methodology for extending MS CRM, and deployed using MS CRM Deployment Manager. These include all changes necessary to the existing CRM screens, in the form of additional buttons or menu links. The buttons or menu links provide a submittal of the current record page to a predetermined Telephony Web Application server destination by passing parameters. This ensures that the Telephony Application can gather information about the origin of the request (i.e. record type, record Globally Unique Identifier (GUID)).

The TM Web Application 202 provides functionality to serve the custom additional forms. This module includes html pages (.aspx), code behind pages (.cs), as well as the style sheets (.css as defined by the MS CRM standards template) associated with the identified forms. The custom forms in the web application provide functionality to enable communication between the user MS CRM Record that is accessed through the CRM Web Application, and the TM client that is deployed on the user machine. The communication to the TM application is performed using .NET remoting.

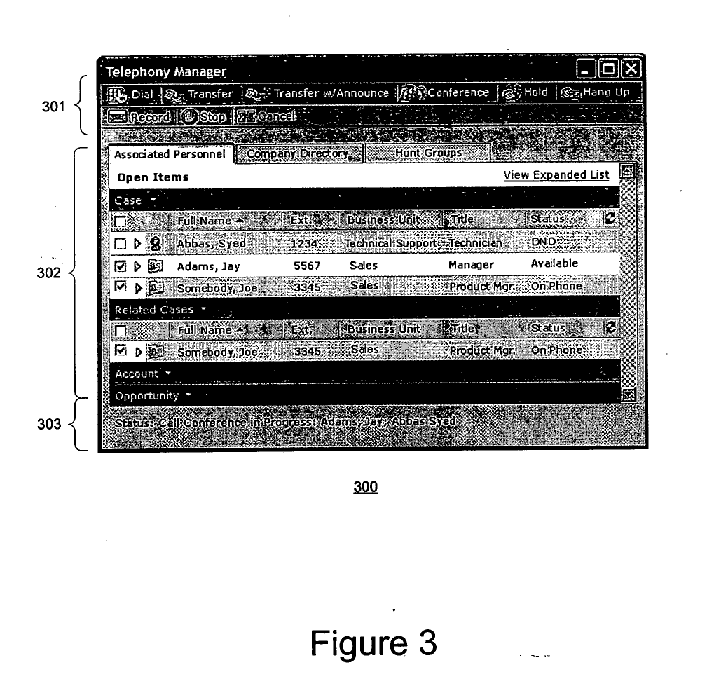

Upon initialization, the TM Application 203 loads the information necessary for loading and initializing the libraries to monitor incoming calls. These settings include the associated extension and IP address of the switch network. Once the application is initialized, it establishes event listening activities for events in the Open Application Interface (OAI) system 204 for incoming calls. The TM Application 203 is a .NET based Windows system tray application deployed on each user machine. Choosing the Windows System Tray application model provides an application that can run in the background, and also have a graphical user interface (GUI) on the client machine (depicted in FIG. 3). The tray application has a polling mechanism to monitor the current user's associated extension. This association is achieved through a software application that allows each user to specify his assigned extension.

When a node becomes unavailable, the system may take up to three minutes before sending a link status “down” signal. When the application event handlers receive this signal, all extensions that belong to this node are marked as “status”: “not available”. When the node comes back up, the system sends another link status indicating the event, at which point the application re-queries the users in that node to gather status information.

FIG. 3 depicts the Telephony Manager Application GUI in accordance with the present invention. The Telephony Manager is a popup screen that enables telephony functionality related to the current record, providing the user the necessary telephony options to enhance the user's experience. The TM activation link is located on all Activity Detail pages within MS CRM. They include: Phone Activity, Email Activity, Fax Activity, Meeting Activity, Task Activity, and Letter Activity.

The TM GUI 300 is divided into three main sections. The top section 301 lists the “telephony” functions as well as a refresh button. This section will provide the following phone integration options: Dial, Transfer, Conference, Record, Hold, and Hang Up. The TM will automatically close if the user selects Transfer (when complete), Hang Up and Forward. The TM stays open when the user selects Record, Conference, Hold, and Dial.

The middle section 302 lists the contact information associated with the record as well as the entire company directory (pulled from the Enterprise Messenger). The Company Directory tab displays the list of personnel as stored in the Enterprise Messenger (EM). The EM contains general information about the company personnel including full name, business unit, extension, title. The EM exposes a Lightweight Directory Access Protocol (LDAP) accessible data source.

The application will note the node associated with the extension being monitored/controlled, as well as the extensions in the directory. Ideally if the application loses a connection to one or more nodes (but not the node the client is controlling) it should still work. Any missing information for the directory list will be listed as unavailable.

The Hunt Groups tab includes the hunt group information as obtained from the Enterprise Messenger. The users within the Hunt Group will come from the OAI. In addition to the hunt group name and extension, each group includes a listing of all the personnel details including personnel status information.

The Associated Personnel tab provides some indication of the availability of the potential call recipient in the complete directory and ‘probable transfer to’ lists. The system provides the name, extension, business unit, title, and some indication of the availability of the call recipient.

MS CRM has no method to tie internal associated contacts to a given record. MS CRM has the concept of “activities” [I would like to add some more detail about activities], which are tied to internal contacts and given accounts. Using this mechanism, the Telephony Manager derives the “associated contacts” by matching the given activities for a record and thus finding all contacts that are related to a given record. In order to be associated with a record, a user must create or be assigned to an activity, the owner of the record, or the shared owner.

The bottom section 303 of the GUI 300 includes status information that describes what action is taking place, and related status notes. This section also describes what the next steps should be during a given status (e.g. selects the contact or cancel).

The Telephony Manager communicates to the System OAI through a “Wrapper” Class Library, which will encapsulate the OAI Commands listed below. This Library might use, e.g., TCP/IP to connect to the Computer Telephony (CT) Gateway/phone switch.

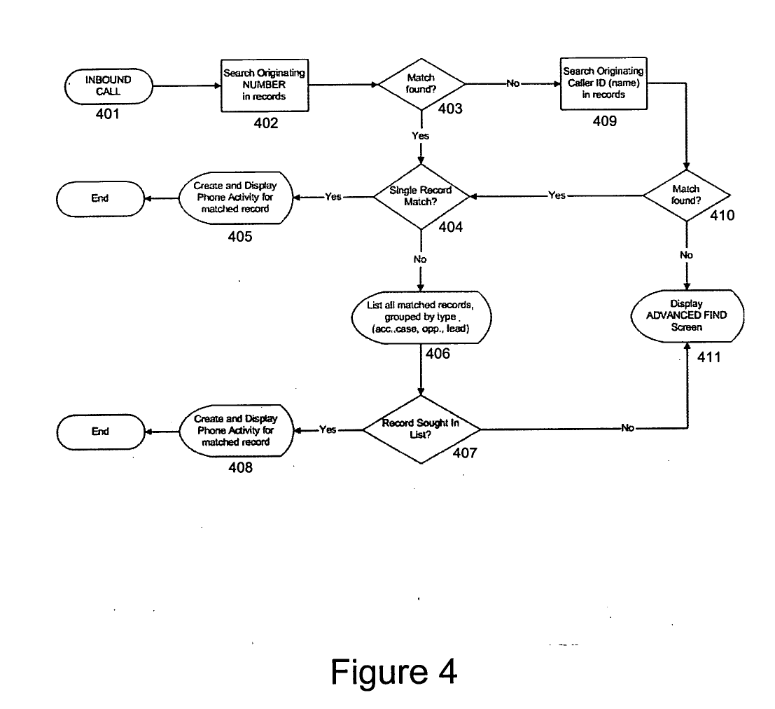

FIG. 4 depicts the process flow for handling inbound calls implemented by the Telephony Manager Application upon detection of an incoming call. When the appropriate action is identified and performed the user is redirected to the appropriate MS CRM screen for that action. The application launches a Web browser with the URL for the MS CRM screen. For example, if the caller is associated with a “lead”, a new phone activity for that lead will be created on the MS CRM server, and the user will be redirected to the URL of that activity. In order to interact with the MS CRM package, the clients are configured to include MS CRM server as well as Telephony Manager Web Application server information.

The Telephony Manager provides the functionality identified in previous sections. This aspect of the application has the most interaction with the OAI Application Programming Interfaces (APIs). A “wrapper” .NET class library enables the required functionality. The configurations established upon application initialization are used to direct the Telephony wrapper to the switches and networks.

The TM requires current status information about the user's phone line, which is available after initialization, as well as on demand. The class library exposes functionality to query and detects status information around the current user's associated phone line. For example, if the user is in the middle of a call, and the application is restarted, the application will need to re-gather information about the current status, and provide appropriate functionality.

This application will also be communicating with the CRM package. Some of the interaction will be initiated from specific CRM package screens. In these cases, the integration mechanisms will facilitate the communication between these systems.

Upon receiving the incoming call 401, the TM will pop up a small window indicating the incoming call in progress. A search is commenced, wherein the system will look for trailing Interactive Voice Response (IVR) information (step 402) and determine if there is a matching account (step 403). The searching starts as the call is delivered to the monitored extension and has the ability to answer the call via the GUI, or the agent may use the phone to answer the call.

If there is account or case information attached to the incoming call by the IVR, the TM will first process this information and determine if there is a single record match (step 404). If a single record is matched and the user clicks the record link, the system will automate the call completion (answer call) by providing the Phone Activity Screen for the record associated with the originating phone number (step 405). The user also has the option to click a drop down menu for more options. For example, if the user clicks the matched record information, a Phone Activity Record is created. If there is a match against a single account, and the user clicks the drop down arrow, the user will have the option to choose the advanced search or view open cases and opportunities associated with the account. The user will then select the appropriate record to create the phone activity. If there was a match against a single lead, the drop down will list only the Advanced Search option.

If multiple matches are found, the TM will indicate that there are multiple matches and automatically populate the “inbound multiple matched records” screen (step 406). The system determines if the record sought is in the list (step 407). When the user selects the appropriate account, the system will create an opportunity for the selected record and create and display the Phone Activity Record (step 408). The drop down will also include options to create a lead, or advanced search. If the sought record is not in the list, the popup form will indicate this and the drop down menu will list only the Advanced Search option (step 411).

If no trailing IVR information exists, the TM inbound engine will look at the caller phone number (step 409) and determine if the caller ID has a match in the records (step 410). If a match exists in the records, the system determines if there is a single or multiple matches (step 404) and proceeds as described above. If there are no matches, then the form will indicate this, and the drop down will list only the Advanced Search option (step 411).

For the Answer function, additional functionality on the pop up window includes the option to “pick up/answer” the incoming call manually. Note that only a single incoming call is handled at any given time. In the cases of direct lines, the application will ignore incoming calls while the phone is active, and the records will not reflect the phone call if the user decides to pick up the phone manually. The application will only display the data for the first incoming call.

If a call comes in while the user is available (i.e. not on a call), the call will bound to the TM application if the user answers. If the user places the call on hold to answer or dial another call, the TM application will ignore the second call and stay bounded to the first call.

In the preferred embodiment of the present invention, the elapsed time between the phone call ringing and the matching records should be four seconds or less.

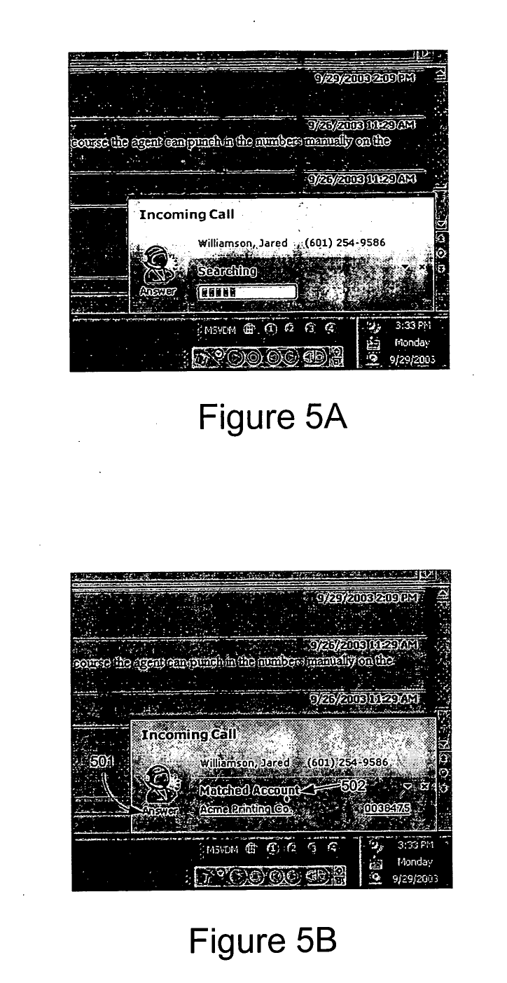

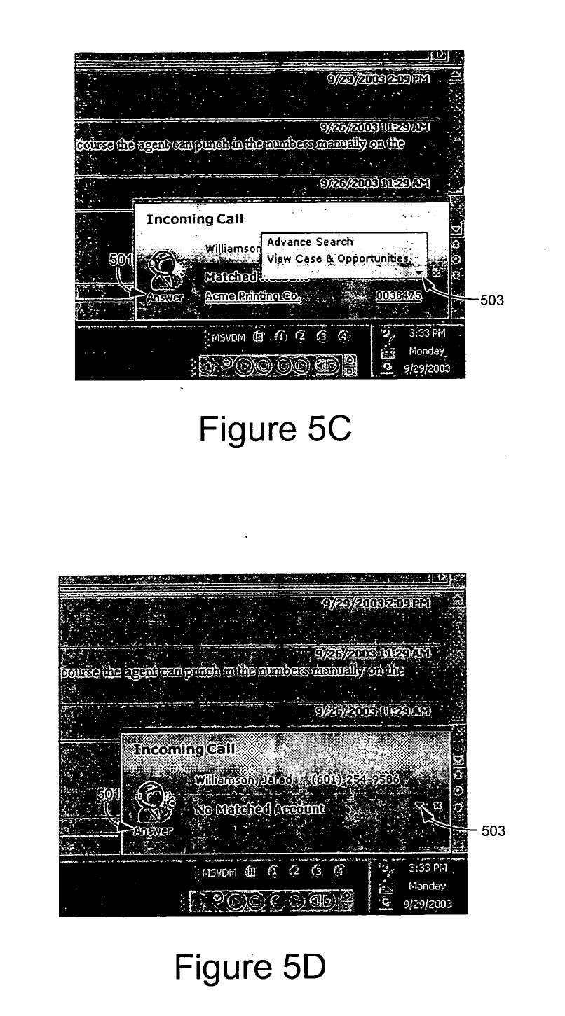

FIG. 5A depicts the TM pop up window displayed when an incoming call is received while the system is searching for account information. The user may answer the call while the records are searching.

FIG. 5B depicts the TM pop up window displayed for an incoming call with matched account information. The user may answer the call by clicking the “Answer” button 501 or click the Matched Account record 502 to answer the call. If the Matched Account record 502 is clicked, a Phone Activity record for that account will appear (this will also apply to a matched lead).

FIG. 5C depicts the TM pop up window with options clicked. Once the call is answered via the “Answer” button 501, the user may choose to click the down arrow 503 for more options. If the Advance Search is clicked, the Advance Search Screen will appear. If the View Case & Opportunities option is clicked, all open cases/opportunities for the matched account will appear. Once the user clicks on the appropriate record, the Phone Activity Screen for that record will appear.

FIG. 5D depicts the TM pop up window for an incoming call with no matches found in the record. Once the call is answered via the “Answer” button 501, the user will have the option to click the drop down arrow to perform the Advance Search.

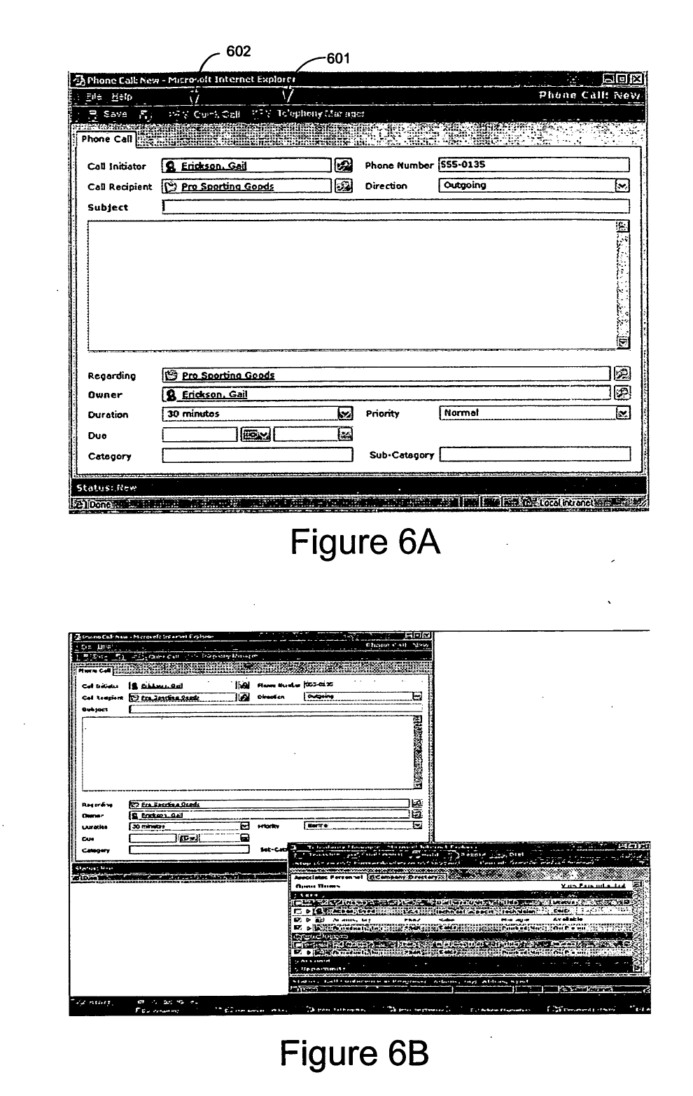

After a call has been answered, the user has several options. If there is one record match, the user may choose to click the matched record to create the Phone Activity View Record, as depicted in FIG. 6A. Alternatively, the user can click the arrow button 503 to view existing open cases or perform an advance search, as described above. Once the correct option has been chosen and the Phone Activity View Record appears the user will have the ability to click on the “Telephony Manager” button 601, which uses the modal maximize TM.aspx page, as shown in FIG. 6B. This action in turn will activate the maximize TM method on the TM Remoting Class via .NET remoting. The aspx page is then closed.

Upon exact record match, the browser is launched with URL reference to the new activity for the record type.

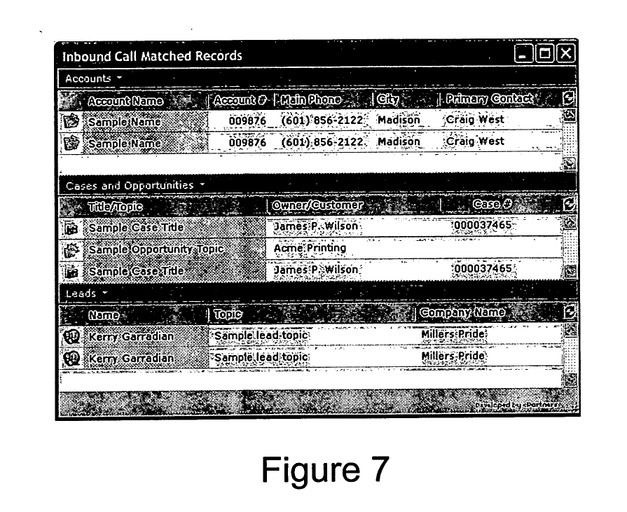

If multiple records match, the incoming call pop up screen as well as a listing of record attributes (e.g. names, account numbers, etc) will appear, as depicted in FIG. 7. The view will list all matches, and group them by the related accounts. At this point, the user has the ability to drill down to any account and view the other matches associated with that account (opportunities, cases). The user may select the appropriate record. Once the appropriate record is selected, the Phone Activity View page will appear as described above.

Whenever there is a match against a case, or an opportunity, the related account record is also shown even if the account record did not match the caller. However, there is a visible indication to indicate that the account itself did not get a match. The indication is made, e.g., using grayed out colors. This information will also be visible in the help bar when the user moves the mouse over the record.

The query must also look at the role of the user. The “edit” rights are set within the security settings of the CRM package, and can be attributed to multiple record types, and teams. The system will indicate if the user does not have edit rights for applicable records. If that narrows to one, the user will be taken to the Phone Activity Screen for that record. If multiple records are matched, the user will have the ability to select the appropriate record. If the user cannot find the appropriate item in the view, can press a “Not Listed Here” button and be transferred to the “Advanced Find” screen (described below).

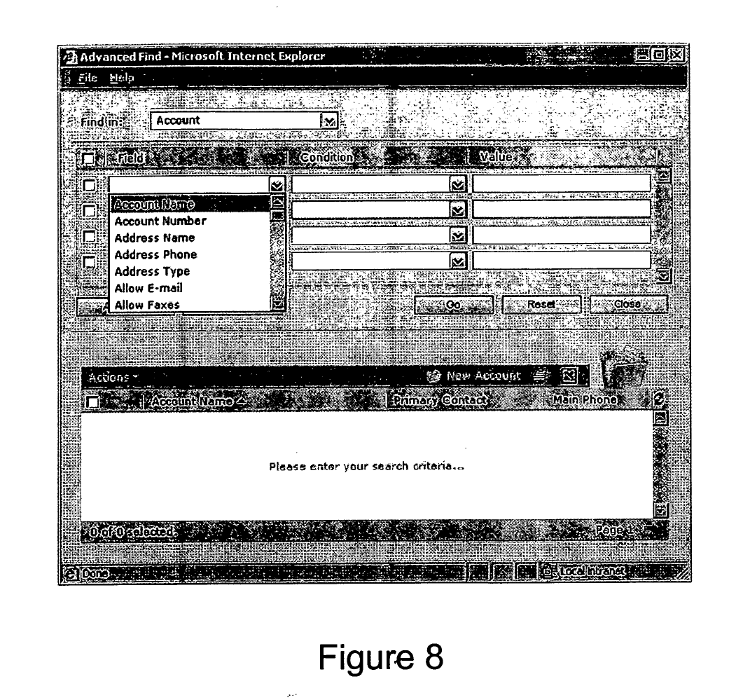

FIG. 8 depicts the Advance Find page in accordance with the present invention. If the system does not find a record match (number or name), the user will have the option to load the Advanced Find Page. The user selects the appropriate record and then manually goes to the Phone Activity View page for the record in order to view the Telephony Manager. In order for this record to populate in the future, the user enters the correct phone number within the associated contact record.

If the case or account number is matched by the IVR, the Phone Activity View record will automatically appear. Query hooks look up an account number or case based on an IVR module handing data to the pre-built hooks. Account codes are used as triggers. Account codes are assigned to a call, and the data stream from an incoming call can be used to hold the incoming account code. The IVR is set up to store the account number information in the “TRUNK_NAME” field associated with the incoming call. This field can store up to 16 alphanumeric characters.

The Dialed Number Identification Service (DNIS) is a tag that is attached to incoming calls when a (potential) client calls a designated number. The system can use the DNIS to extract the number being called. If the DNIS information is available, the system will detect whether the incoming caller is currently associated with records in the system. If there are multiple associations, the system will display the accounts that contain associations with the customer, and the user will select the appropriate one. If there is only a single account that has associations with the customer, the system will not display the multiple account screen. Upon determining the account, the pop up screen will indicate the matched result, and give the user the option to create a new opportunity for the matched account.

If there are no matches, or the user indicates that the list of matches in the system did not apply to the caller, the message on the pop up screen will indicate this status. At any given time, the user will have the option to create a new lead or initiate Advance Search.

The user initiates outbound calls after the record has been identified. When dialing from a viewed screen, the contact to call defaults to the currently open contact record. If the contact has multiple phone numbers within the database, the user selects the appropriate phone number from a list with the phone descriptions. Upon selection, the call is placed and the popup window will disappear. At this point, the Telephony Manager will be maximized and the associated personnel will also be populated.

Referring back to FIG. 6A, if the user selects the “Quick Dial” button 602, the pop-up screen will only display the phone numbers that were visible on the CRM form.

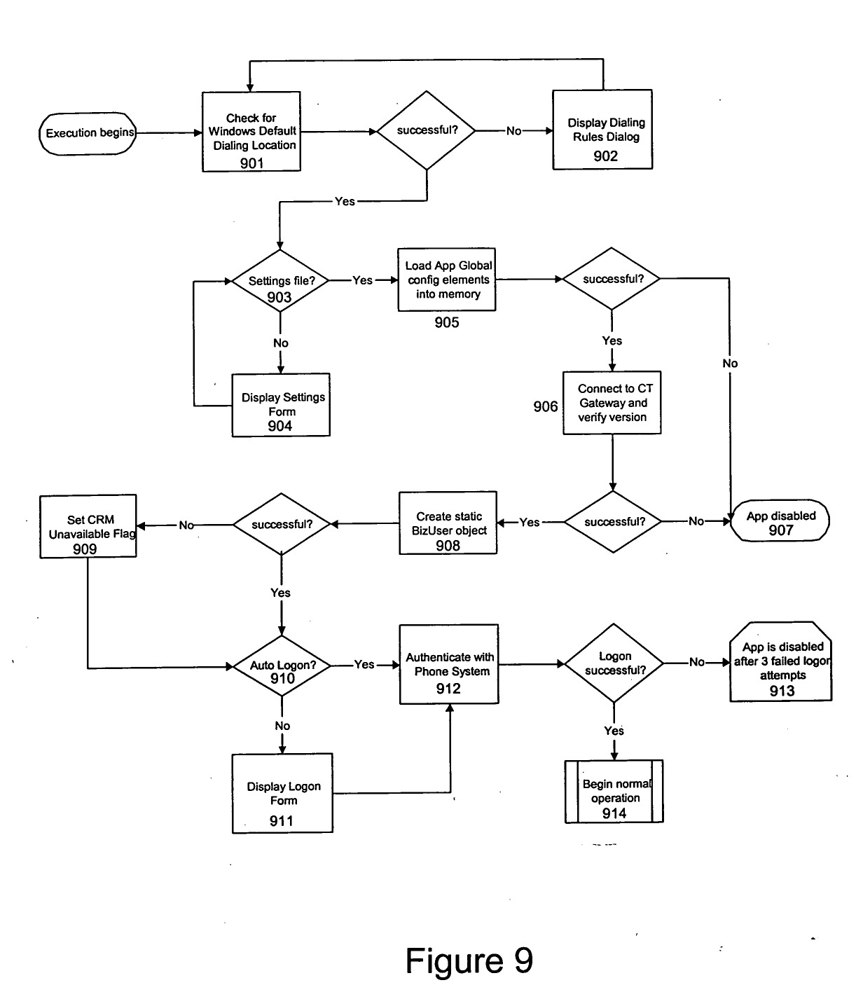

FIG. 9 depicts the process flow of the TM initialization sequence. After execution of the initialization begins, the system checks for the Windows default dialing location (step 901). If the search is not successful, the system displays a dialing rules dialog box (step 902). This dialog box allows the user to specify the dialing location. The system then returns to step 901 and tries again.

If the system successfully finds the dialing location it then determines if there is a setting file (step 903). If there is no setting file, the system displays a settings form for the user to complete and then checks the setting file again. Once the setting file is found, the system loads the TM Application global configuration elements into memory (step 905). If the system is not successful in loading the configuration elements, the TM Application is disabled (step 907).

If the configuration elements are successfully loaded into memory, the system connects to the CT gateway and verifies the version (step 906). If the connection to the CT gateway is not successful, the TM application is disabled (step 907).

Once the system has successfully connected to and verified the CT gateway it creates a static business user object (step 908). If this step is not successful, the system sets a CRM Unavailable flag (step 909). The system then determines if the automatic logon is enabled (step 910).

If automatic logon is available, the system automatically authenticates with the phone system (step 912). If automatic logon is not available, the system displays a logon form to the user (step 911).

If logon is successful, the system begins normal operation (step 914). The TM application is disabled after three failed logon attempts (step 913).

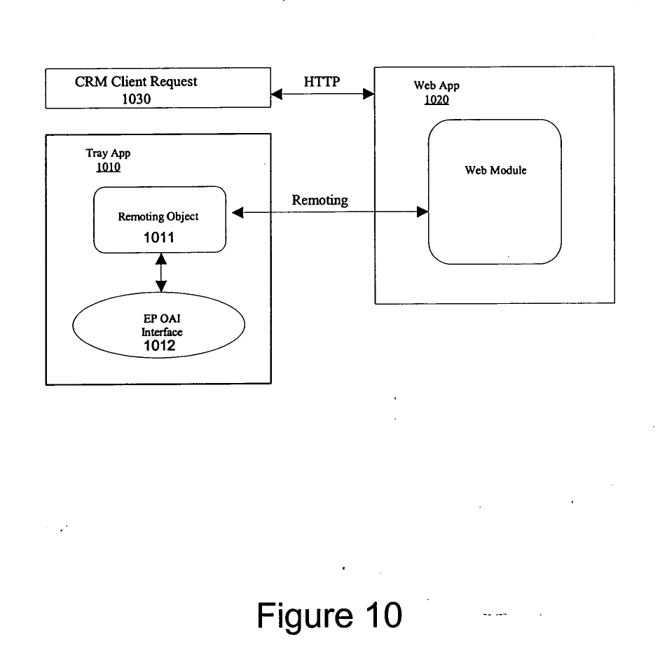

FIG. 10 depicts CRM integration into the Telephony Manager Application. The System Tray application 1010 listens in on a predetermined TCP/IP port for instructions from the Telephony Manager Web Application 1020, which is necessary for MS CRM activated commands, e.g. Quick Call.

Upon the selection of, e.g., “Quick Call” or other Telephony Activity command 1030 in MS CRM extended screens, the request is submitted to the TM Web Application 1020. This application will determine the IP address of the requesting client, and relay the message to the TM client 1010 installed at the user machine, using .NET remoting. Once the message is relayed to the client application 1010, Telephony Manager will perform the commands.

One or more objects 1011 that encapsulate calls to the OAI library 1012 will be exposed to the web application via .Net Remoting. Once an exposed object is instantiated and a method is called, it will in turn call the corresponding OAI library method(s).

The TM communicates with the OAI through the OAI class library 1012. In addition, the application is able to listen for events in OAI for incoming calls. This may or may not be available depending on the event system of the OAI system. If it is available, then the class library will provide this functionality to the TM application. The initialization steps will need to be complete, and the configurations of the network switch locations and the extension information will need to be in place before the application can interact with the OAI interface.

The OAI interface is used to gather status information and inbound call event management. The interface requires information about the CT Gateway in order to perform OAI operations.

Once the telephony manager gathers enough information about an action, the application will access and perform activities in the CRM server and provide the interface to the user. In order to achieve this, the application will need to know the location information for the CRM server as specified in the configuration file details.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A customer relationship management (CRM) telephony management system, comprising:
a server-based CRM application and CRM extensions that provide access to customer records and enable telephony action;
a client-based telephony manager application that monitors and performs telephony functions and provides a graphical user interface (GUI); and
a server-based telephony web application that hosts custom forms to facilitate communication between CRM records and the telephony manager application;
wherein the telephony management system automatically retrieves any existing CRM records associated with the identity of incoming calls; and
wherein a user may answer incoming calls with said GUI.

2. The telephony management system according to claim 1, wherein the telephony manager application provides at least one of the following telephone functions via the GUI:
dial;
transfer;
conference;
record;
hold; and
hang up.

3. The telephony management system according to claim 1, wherein the CRM extensions include changes to CRM screens in the form of additional buttons and menu links.

4. The telephony management system according to claim 1, wherein the telephony web application may provide html pages, code behind pages, and style sheets associated with identified forms.

5. The telephony management system according to claim 1, wherein the telephony manager application establishes event listening activities for events in an Open Application Interface (OAI) system for incoming calls.

6. The telephony management system according to claim 5, wherein the telephony manager application communicates to the OAI system through a wrapper class library that encapsulates OAI commands.

7. The telephony management system according to claim 1, wherein the telephony manager application is a .NET-based Windows system tray application.

8. The telephony management system according to claim 1, wherein the telephony manager application has a polling mechanism to monitor the status of a current user's associated extension.

9. The telephony management system according to claim 1, wherein the telephony manager application derives associated contacts for a given CRM record by matching CRM activities for said record, wherein the CRM activities relate to internal contacts and accounts.

10. The telephony management system according to claim 1, wherein if a single record is matched to an incoming call, and the user clicks a record link displayed in the GUI, the system automatically answers the call by providing a phone activity screen for the record associated with the call.

11. The telephony management system according to claim 1, wherein if multiple records are matched to an incoming call, the telephony manager application automatically populates a matched records screen, and wherein if the user selects an account from said matched records screen, the system creates a phone activity record and displays a phone activity screen associated with the call.

12. The telephony management system according to claim 1, wherein if the system finds no matching records for an incoming call, the user may load an advanced find page, wherein the user selects an appropriate record and manually goes to a phone activity view page for that record.
